(19) United States
(12) Patent Application Publication
(10) Pub. No.: US 2025/0130030 A1
(43) Pub. Date: Apr. 24, 2025

(54) SYSTEMS AND METHODS FOR HOMOGENIZING MECHANICALLY-GASSED EXPLOSIVES

(71) Applicant: Dyno Nobel Inc., Salt Lake City, UT (US)

(72) Inventors: John Halander, Salt Lake City, UT (US); Casey Nelson, Salt Lake City, UT (US)

(21) Appl. No.: 18/918,930

(22) Filed: Oct. 17, 2024

Related U.S. Application Data
(60) Provisional application No. 63/592,099, filed on Oct. 20, 2023.

(51) Int. Cl. F42D 1/10; B01F 23/232; B01F 25/441; B01F 25/442; B01F 35/30; B01F 101/49

(52) U.S. Cl. CPC F42D 1/10; B01F 23/232; B01F 25/4413; B01F 25/4422; B01F 2035/351; B01F 2101/49

(57) ABSTRACT

Systems and methods for delivering explosive mixtures with gas bubbles that are resistant to in-borehole migration or coalescence are disclosed herein. Such explosive can be sensitized by mechanically introducing gas bubbles into the explosive matrix in a number of gassing stages. Resistance to gas bubble migration and coalescence without the need for bubble stabilization agents can be achieved by homogenization in a number of homogenizing stages.

### CROSS-REFERENCE TO RELATED APPLICATIONS

This application claims priority to U.S. Provisional Patent Application No. 63/592,099, entitled “SYSTEMS AND METHODS FOR PREPARING MECHANICALLY-GASSED EXPLOSIVES,” filed on Oct. 20, 2023, which is incorporated herein by reference in its entirety.

### TECHNICAL FIELD

The present disclosure relates generally to the field of explosive compositions. More particularly, the present disclosure relates to mechanically-gassed explosives and related systems.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a schematic diagram illustrating one embodiment of a process flow for manufacturing mechanically-gassed emulsion explosive.

FIG. 2 is a section view of a system for manufacturing mechanically-gassed emulsion explosive according to an embodiment.

FIG. 3A is a section view of an injection port from the system illustrated in FIG. 2.

FIG. 3B is an end view of an injection port from the system illustrated in FIG. 2

FIG. 4 is a section view of an injection port and a nozzle from the system illustrated in FIG. 2.

FIG. 5A is a section view of an annular gas injector from the system illustrated in FIG. 2.

FIG. 5B is a section view of selected components from the annular gas injector.

FIG. 5C is an exploded section view of selected components from the annular gas injector.

FIG. 5D is an end view of one of the components illustrated in FIG. 5C.

FIG. 6A is a section view of a gas injection cassette from the system illustrated in FIG. 2.

FIG. 6B is a cross section view of the gas injection cassette taken at the plane indicated in FIG. 6A.

FIG. 6C is a detail view of a component of the gas injection cassette.

FIG. 7A is a section view of a pre-shear valve in accordance with an embodiment.

FIG. 7B is an exploded detail view of selected components of the pre-shear valve.

FIG. 7C is a cross section view of the pre-shear valve taken at the plane indicated in FIG. 7A.

FIG. 8A is a section view of an example embodiment of the homogenizer from the system illustrated in FIG. 2.

FIG. 8B is a detail view of selected components of the homogenizer.

FIG. 8C is a detail view of another selection of components of the homogenizer.

FIG. 8D is an end view of the homogenizer.

FIG. 9A is a section view of another example embodiment of the homogenizer from the system illustrated in FIG. 2.

FIG. 9B is a section view of a mixer component of the homogenizer shown in FIG. 9A.

FIG. 9C is an end view of an element of the mixer shown in FIG. 9B.

FIG. 9D is an end view of another element of the mixer shown in FIG. 9B.

FIG. 9E is a diagram based upon an end view of the mixer shown in FIG. 9B.

FIG. 10A is a section view of selected components of a delivery conduit in accordance with an embodiment.

FIG. 10B is a section view of a nozzle from the delivery conduit.

FIG. 10C is a front view of selected components of the nozzle.

### DETAILED DESCRIPTION

This disclosure generally relates to bulk materials to be used as explosives, along with related systems and methods. The present disclosure discusses water-in-oil (or melt-in-oil) emulsions as an exemplary explosive mixture for the purposes of illustrating the embodiments described herein; however it will be understood that other explosive mixtures are contemplated, including but not limited to, water gels, slurry explosives, and blends thereof (e.g., blends of emulsions, water gels, or slurry explosives with ammonium nitrate (AN) or ammonium nitrate-fuel oil (ANFO)).

The term “water-in-oil” means a dispersion of droplets of an aqueous solution or water-miscible melt (the discontinuous phase) in an oil or water-immiscible organic substance (the continuous phase). The water-in-oil emulsion explosives discussed herein contain a water-immiscible organic fuel as the continuous phase and an emulsified inorganic oxidizer salt solution or melt as the discontinuous phase. (The terms “solution” or “melt” hereafter shall be used interchangeably.) Emulsion explosives are commonly used in the mining, quarrying, and excavation industries for breaking rocks and ore. Generally, a hole, referred to as a “blasthole” or “borehole,” is drilled in a surface, such as the ground. Emulsion explosives may then be pumped or augered directly into the blasthole or, alternatively, may be packaged before placement in the blasthole. Emulsion explosives are generally transported to a job site or made on the job site as an emulsion that is too dense to completely detonate, referred to as an emulsion matrix. The emulsion matrix is not considered an explosive. In general, the emulsion matrix needs to be “sensitized” in order for the emulsion matrix to detonate successfully. A sensitized emulsion matrix is considered an emulsion explosive. Sensitizing is often accomplished by introducing small voids into the emulsion matrix. These voids act as hot spots for propagating detonation. These voids may be introduced by injecting a gas into the emulsion and thereby forming discrete gas bubbles, adding microspheres, other porous media, and/or injecting chemical gassing agents to react in the emulsion and thereby form discrete gas bubbles.

The emulsion matrix can be designed to be repumpable. A repumpable emulsion matrix can be manufactured at a facility and then pumped into a storage reservoir of a mobile processing unit (e.g., transport truck). The repumpable emulsion matrix can then be safely and economically pumped again on the mobile processing unit to provide sufficient kinetic energy to process the emulsion matrix into an emulsion explosive and deliver the emulsion explosive to a borehole. In the present disclosure, sensitization of the emulsion matrix can be incorporated into the process of delivering the emulsion matrix from the mobile processing unit to the borehole.

Systems for delivering explosives and methods related thereto are disclosed herein. It will be readily understood that the modules of the embodiments as generally described below and illustrated in the Figures herein could be arranged and designed in a wide variety of different configurations. Thus, the following more detailed description of various embodiments, as described below and represented in the Figures, is not intended to limit the scope of the disclosure, but is merely representative of various embodiments. While the various aspects of the embodiments are presented in drawings, the drawings are not necessarily drawn to scale unless specifically indicated.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.”

The phrases “operably connected to,” “connected to,” and “coupled to” refer to any form of interaction between two or more entities, including mechanical, electrical, magnetic, electromagnetic, fluid, and thermal interaction. Likewise, “fluidically connected to” and “fluid communication” are each used in their ordinary sense, and are broad enough to refer to arrangements in which a fluid (e.g., a gas or a liquid) can flow from one element to another element. Two entities may interact with each other even though they are not in direct contact with each other. For example, two entities may interact with each other through an intermediate entity.

A method for delivering an explosive material can comprise obtaining an unsensitized energetic material, processing the material to produce an explosive material, and delivering the explosive material to a borehole. For example, delivering an emulsion explosive can comprise obtaining a water-in-oil emulsion matrix that includes a discontinuous phase of oxidizer salt solution droplets in a continuous phase of a fuel. The fuel may be a mixture of a diesel fuel (which may alternatively be referred to as “fuel oil,” or in specific embodiments “fuel oil #2”) and an emulsifier, such as a fatty acid. In some embodiments, the emulsion matrix is about 90% to about 96% oxidizer salt solution and about 4%-10% fuel (weight per weight), such as about 94% oxidizer salt solution and about 6% fuel. In some embodiments, the oxidizer salt solution is about 70% to about 90% ammonium nitrate by weight. The emulsion matrix can be manufactured at a facility and then pumped into a storage reservoir of a mobile processing unit (e.g., transport truck). The emulsion matrix can be sensitized and refined to produce a stable emulsion explosive.

Sensitization can comprise introducing gas bubbles into the emulsion matrix, a process also referred to as “gassing.” In the present disclosure, the introduction of gas bubbles into the emulsion matrix may be accomplished mechanically, such as by delivering a stream of compressed gas into a stream of the emulsion matrix and causing a combination of the gas and emulsion matrix so as to create a stable distribution of gas bubbles within the emulsion matrix. In some embodiments, gassing may be performed in a plurality of stages. More particularly, other processing steps may be performed in an interval between gassing stages. In some embodiments, a gassing stage may be followed by—or coincident with—a processing step to promote incorporation of the gas into the emulsion matrix and/or to modify a property of the emulsion matrix. In some embodiments, the modification may promote a stable distribution of gas bubbles within the emulsion matrix. In some embodiments, the modification may comprise reducing the size of gas bubbles in the emulsion matrix. In some embodiments, the modification comprises an increase in the viscosity of the emulsion matrix. Such processing steps may be followed by further gassing stages.

In various embodiments, sensitizing an emulsion matrix may comprise 1 to 7 gassing stages. In particular embodiments, sensitizing can comprise 1, 2, 3, 4, 5, 6 or 7 or more gassing stages. After one or more gassing stages, the emulsion matrix is sensitized to some degree which may be sufficient to render it detonable. However, in some cases, the suitable level of explosive energy may vary from borehole to borehole. Accordingly, in some embodiments sensitization of the emulsion matrix may be completed just prior to, or coincident with, delivery of the emulsion matrix into a borehole.

After one or more gassing stages, the resulting emulsion explosive may then be homogenized, where “homogenize” refers to reducing the size of droplets of a discontinuous phase component in an emulsion, such as droplets of oxidizer phase within the fuel phase of a water-in-oil emulsion matrix. In some embodiments, homogenization is achieved by subjecting the emulsion explosive to shear stress. An increase in the viscosity of the emulsion explosive may result from homogenization. In some embodiments, a homogenized emulsion explosive having a relatively high viscosity may be manufactured by first obtaining a relatively low viscosity emulsion matrix and then sensitizing and homogenizing the emulsion matrix. The emulsion matrix may initially have a viscosity of about 4,000 to about 60,000 cP, such as about 4,000 cP to about 8,000 cP, about 7,000 cP to about 10,000 cP, about 8,000 cP to about 14,000 cP, about 10,000 cP to about 20,000 cP, about 12,000 cP to about 30,000 cP, about 15,000 cP to about 40,000 cP, about 20,000 cP to about 50,000 cP, or about 30,000 cP to about 60,000 cP. The viscosity can be measured with a Brookfield viscometer, such as a Model #HADVII+with an LV-3 spindle at 20 rpm and temperature at 20° C.

In some embodiments, the viscosity of the homogenized emulsion explosive may, due to homogenization, be increased relative to the emulsion matrix by more than about 80,000 cP, such as by at least about 50,000 cP, at least about 60,000 cP, at least about 80,000 cP, at least about 100,000 cP, at least about 150,000 cP, or at least about 300,000 cP. Additional increases in viscosity may result from shear stress imparted in other processing steps. In some embodiments, the viscosity of the final emulsion explosive relative to the emulsion matrix may be increased by about 130,000 cP to about 500,000 cP, about 150,000 cP to about 250,000 cP, about 200,000 cP to about 300,000 cP, about 250,000 cP to about 350.00 cP, or about 300,000 cP to about 500,000 cP.

In some embodiments, the viscosity of the homogenized emulsion explosive may be greater than or equal to 80,000 cP. For example, the homogenized emulsion explosive may have a viscosity of about 80,000 cP to about 400,000 cP, such as about 80,000 cP to about 100,000 cP, about 90,000 cP to about 120,000 cP, about 105,000 cP to about 135,000 cP, about 120,000 cP to about 150,000 cP, about 140,000 cP to about 200,000 cP, about 190,000 cP to about 250,000 cP, about 240,000 cP to about 300,000 cP, or about 290,000 cP to about 400,000 cP.

In some embodiments, homogenization can comprise two or more homogenizing stages. In particular embodiments, homogenization can comprise 2, 3, 4 or 5 homogenizing stages. In some embodiments, a homogenizing stage may be preceded or followed by a gassing stage.

In some embodiments, the homogenized emulsion explosive lacks or is substantially devoid of gas bubble stabilizing agents, such as haloalkyl esters, small particles, and proteins. The phrase “bubble stabilizing agent” or “foaming agent” refers to a composition that reduces the rate of bubble coalescence in a gas-infused emulsion relative to an essentially identical gas-infused emulsion that lacks the bubble stabilizing agent. In some embodiments, the homogenized emulsion explosive lacks bubble stabilizing agents such as haloalkyl esters (including fluoroaliphatic polymer esters), small particles (such as silica particles, iodipamide ethyl ester particles, and various colloidal particles), and proteins. By way of example, the homogenized emulsion explosives may be devoid of any haloalkyl esters, small particles, and proteins. The excluded small particles may range in size from submicron (e.g., 20 nm) to 50 microns in size. Stated differently, the homogenized emulsion explosives may lack foaming agents or surfactants that stabilize gas bubbles in the emulsion.

In contrast to bubble stabilizing agents, in some embodiments, the emulsion comprises an emulsifier, a homogenizing agent, or both. The emulsifier may be chosen from any suitable emulsifier and may be part of the fuel, and thus, part of the continuous phase. For example, the fuel may include up to 25 weight percent of an emulsifier, homogenizing agent, or both. For example, the homogenizing agent may be from 20 percent to 100 percent of the emulsifier/homogenizing agent in the fuel. Thus, for example, when the fuel is about 6 weight percent of the homogenized emulsion, the homogenizing agent may be about 0.3% to about 1.5% of the homogenized emulsion, by weight.

Examples of emulsifiers and homogenizing agents that may be selected for use include alcohol alkoxylates, phenol alkoxylates, poly (oxyalkylene)glycols, poly (oxyalkylene) fatty acid esters, amine alkoxylates, fatty acid esters of sorbitol and glycerol, fatty acid salts, sorbitan esters, poly (oxyalkylene) sorbitan esters, fatty amine alkoxylates, poly (oxyalkylene)glycol esters, fatty acid amides, fatty acid amide alkoxylates, fatty amines, quaternary amines, alkyloxazolines, alkenyloxazolines, imidazolines, alkylsulfonates, alkylarylsulfonates, alkylsulfosuccinates, alkylphosphates, alkenylphosphates, phosphate esters, lecithin, copolymers of poly (oxyalkylenc)glycols, and poly(12-hydroxystearic acid). In some embodiments, the emulsifier is polyisobutenyl succinic anhydride (PIBSA). For example, PIBSA may be used as an emulsifier in repumpable emulsion matrix. In some embodiments, the emulsifier is sorbitan monooleate. For example, sorbitan monooleate may be used in a site-mixed emulsion matrix.

The increased viscosity of the homogenized emulsion explosive may reduce gas bubble migration and/or gas bubble coalescence, thereby resulting in an emulsion explosive of increased compositional stability. In other words, due at least in part to the increase in viscosity of the homogenized emulsion explosive, the gas bubbles within the emulsion may have decreased mobility and/or a decreased propensity to merge with other gas bubbles.

By contrast, a mechanically gassed emulsion explosive of relatively low viscosity, that does not include a bubble stabilization agent, tends to have bubble migration and coalescence problems. When the gas-infused emulsion explosive of relatively low viscosity, that does not include a bubble stabilization agent, is placed in a borehole, gas bubbles in the emulsion may migrate upwards (due to the low density of gas relative to the emulsion), thereby resulting a composition in which gas bubbles are unevenly distributed throughout the emulsion. The uneven distribution of gas bubbles leads to emulsion explosives of decreased homogeneity, undesired performance, and potential undetonability. Bubbles within an emulsion of relatively low viscosity may also, due in part to their increased mobility, tend to coalesce with other gas bubbles. The increased coalescence of gas bubbles in an emulsion explosive also results in decreased homogeneity, undesired performance, and potentially undetonability. Mechanically-gassed homogenized emulsion explosives manufactured as described herein that have a relatively high viscosity may be more resistant to gas bubble migration and/or coalescence without the need for a bubble stabilization agent.

The mechanically-gassed homogenized emulsion explosives described herein may be additionally processed in other ways that are known in the art. For example, a lubricant, such as water, may be introduced while the homogenized emulsion is delivered through a conduit to a borehole. Additional components, such as solid sensitizers and/or energy increasing agents, may be mixed with the homogenized emulsion explosives. Examples of solid sensitizers include, but are not limited to, glass or hydrocarbon microballoons, cellulosic bulking agents, expanded mineral bulking agents, and the like. Examples of energy increasing agents include, but are not limited to, metal powders, such as aluminum powder, and solid oxidizers. Examples of the solid oxidizer include, but are not limited to, oxygen-releasing salts formed into porous spheres, also known in the art as “prills.” Examples of oxygen-releasing salts include ammonium nitrate, calcium nitrate, and sodium nitrate. Any solid oxidizer known in the art and compatible with the fuel of the homogenized emulsion explosive may be used. The homogenized emulsion explosives may also be blended with explosive mixtures, such as ammonium nitrate fuel oil (“ANFO”) mixtures.

The mechanically-gassed homogenized emulsion explosives described herein can be used as bulk or packaged explosives, both in above ground and underground applications. All of the method steps described herein may be performed via a mobile processing unit. Once disposed within a borehole, the mechanically-gassed homogenized emulsion explosive may be detonated in any suitable manner. For example, the mechanically-gassed homogenized emulsion explosives described herein with low enough water may be sufficiently sensitized to be detonated with a No. 8 blasting cap when unconfined or in a blasthole above the critical diameter for the particular density.

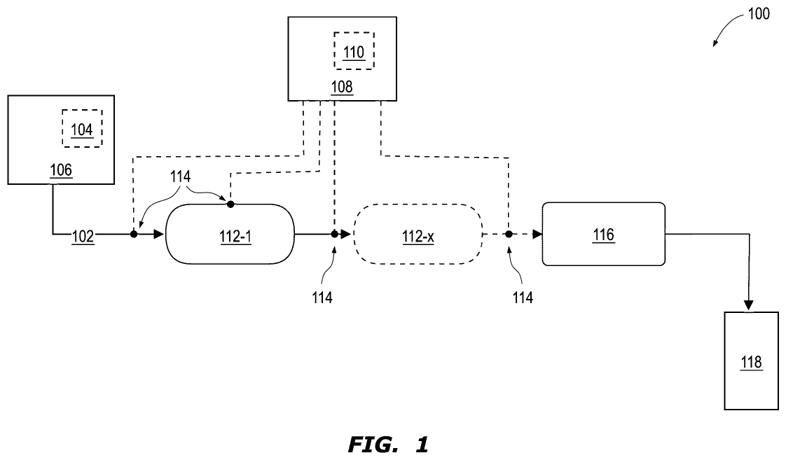

Processing an emulsion matrix as described above to produce an emulsion explosive can comprise the use of an explosives delivery system. In some embodiments, such a system may be substantially contained within a mobile processing unit (e.g., transport truck). FIG. 1 shows a process flow diagram of an explosives delivery system 100 in accordance with the present disclosure. The system can be configured to receive a stream 102 of emulsion matrix 104 from a reservoir 106. The system 100 can comprise a plurality of modules 112-1-112-x, where x=2 to 10, for sensitizing and refining a stream 102 of the emulsion matrix 104. The system 100 can be configured to sensitize the emulsion matrix 104 by introducing gas bubbles into the stream 102. More particularly, the gas bubbles may be mechanically introduced into the stream 102 and combined with the emulsion matrix by one or more modules of the system 100. For example, in the process flow shown in FIG. 1, the system 100 can comprise a gas source 108 fluidically connected to the stream 102 at one or more injection ports 114 configured to deliver a stream of a gas 110 into the flow path. As shown in FIG. 1, the system 100 may include an injection port at one or more of a plurality of locations along the flow path. In various embodiments, injection port locations may be described with respect to one or more modules. For example, an injection port may be situated upstream or downstream of an individual module, or alternatively incorporated into a module. In some embodiments, gas injection ports may be situated upstream or downstream of multiple modules or all of the modules.

In various embodiments, one or more modules of the system 100 may be configured to impart shear to the emulsion matrix for refinement purposes, such as to thicken, stabilize or otherwise modify the emulsion matrix.

The flow path can comprise at least one homogenizer 116. In some embodiments, the homogenizer 116 operates by subjecting the emulsion explosive to shear stress. In some embodiments, a homogenizer 116 may be configured for plural homogenizing stages. The homogenizer 116 may be configured to alter the size distribution of oxidizer salt solution droplets in the emulsion explosive in each homogenizing stage. For instance, in some embodiments, the homogenizers may disrupt relatively large droplets of oxidizer salt solution, thereby converting such droplets into smaller droplets that have a more narrow size distribution. Such manipulation of the oxidizer salt solution droplets may cause an increase (e.g., a significant increase) in the viscosity of the homogenized emulsion explosive. The homogenizer 116 may be primarily responsible for the total shear imparted to the emulsion matrix stream 102 by the system 100.

The system 100 can also comprise a delivery conduit 118 fluidically connected to the homogenizers 116. The delivery conduit 118 may be configured for insertion into a bore hole and for ejecting the stream 102 of sensitized emulsion into the bore hole. In some embodiments, the delivery conduit 118 may comprise at its distal end a structure or component for directing or controlling ejection of the stream into the bore hole, such as a spray nozzle. In some embodiments, the delivery conduit 118 can include one or more structures or components for gassing or refining the stream 102. For example, the delivery conduit 118 may be configured to perform a gassing step that results in the explosive having a density tailored to characteristics of a borehole. In some embodiments, the delivery conduit 118 may include a homogenizer.

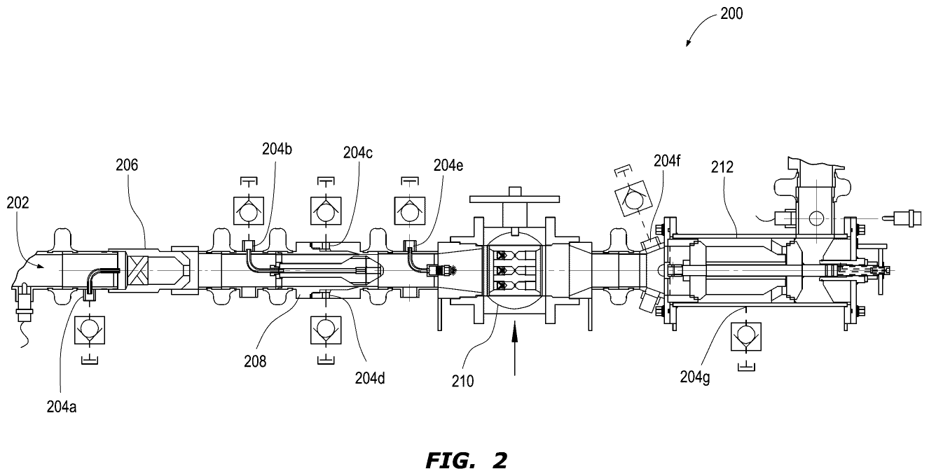

An explosives delivery system 200 according to an exemplary embodiment is shown in FIG. 2. The system 200 can comprise a flow path 202 configured to receive a stream of an emulsion matrix and convey said stream to a bore hole. The flow path 202 can comprise a plurality of modules through which the stream is directed, where some or all of the modules are configured to process the emulsion matrix comprising the stream. In some embodiments, each module can be removably connected to the modules directly adjacent to it, so that the modules may be arranged in a plurality of different sequences along the flow path 202. Some or all of the modules may be housed within a mobile processing unit. Kinetic energy for moving the emulsion matrix through the modules may be provided by a pump (not shown) configured for pumping the emulsion matrix at a sufficient pressure.

The system 200 can comprise a plurality of injection ports 204a-204g, each of which is configured to be fluidically connected to a gas source (not shown) and to inject gas into the flow path 202 when the injection port is thus connected. As shown, the injection ports may be optionally placed at various points along the flow path 202. Furthermore, various combinations of injection port locations may be utilized to sensitize a stream of emulsion matrix. In some embodiments, the system 200 can comprise 1 to 10 injection ports connected to a gas source. In particular embodiments, the system 200 can comprise 2 to 8, 2 to 5, 3 to 7, or 4 to 6 injection ports.

In some embodiments, injection ports may be situated so as to deliver gas into the stream at a point adjacent to or coincident with a particular module. Such a component may be configured to combine the injected gas with the emulsion matrix in the stream.

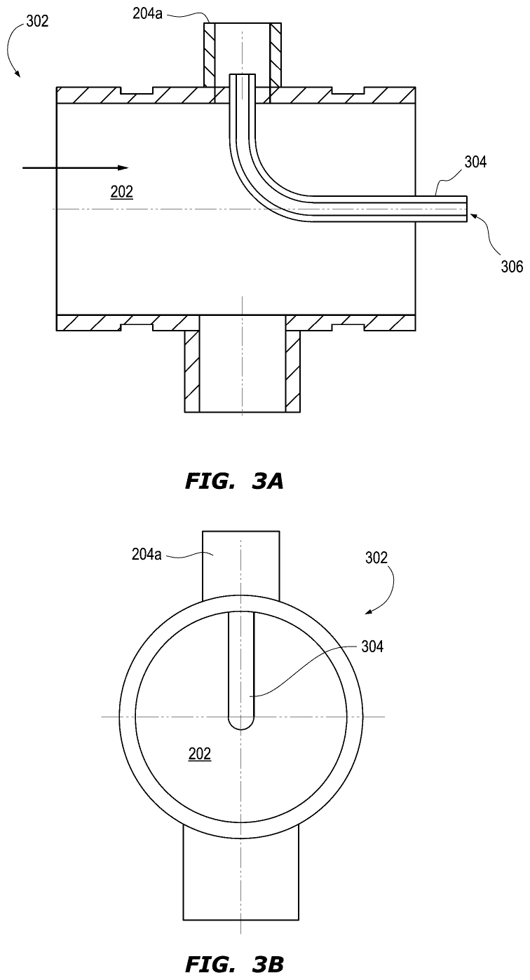

One or more injection ports in the system may be incorporated into an injection module configured to provide an operable connection between the injection port and an adjacent module. A section view and an end view of an example injection module 302 are shown in FIG. 3A and FIG. 3B respectively. As shown, the injection module can comprise an injection port 204a in communication with the flow path 202. A flow of gas may be provided by an injection line 304 in fluid communication with a gas source and configured to convey gas therefrom. In some embodiments, the injection port may include a valve (not shown), such as a ball check valve, or another mechanism suitable for controlling the flow of gas into the injection port. The injection line 304 may pass into the flow path 202 through the injection port 204a. Gas conveyed by the injection line 304 is delivered into the flow path 202 via a terminal end 306 of the injection line 304. In some embodiments, the terminal end may include a structure, such as a spray nozzle, to effect delivery of the gas into the flow path 202. In certain embodiments, the nozzle can be configured for delivery having selected parameters such as flow rate, pressure or median bubble size. In particular embodiments, the median bubble size may be about 1 to 50 microns. The flow rate of the gas may be selected to achieve a desired density of the resulting sensitized emulsion.

The terminal end 306 may be situated axially at a position within the flow path 202 suited for combining the gas with the emulsion matrix. For example, as shown in FIG. 3A, the terminal end 306 may be situated at or near the center of the flow path 202. Alternatively, the position of the terminal end may be radially offset from the center. In another aspect, the injection line may be configured to impart a direction to the flow of delivered gas relative to the flow of emulsion matrix. For example, as shown in FIG. 3A the injection line 304 may direct gas flow in substantially same direction (indicated by the arrow) as the flow of emulsion matrix, or alternatively in a substantially opposite direction, or at an angle to the flow of emulsion matrix.

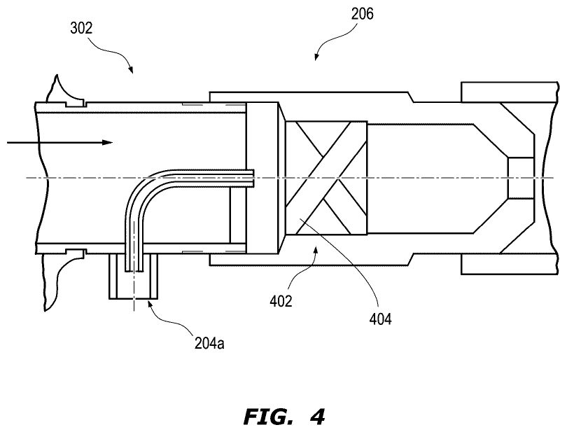

Referring back to FIG. 2, the system 200 may comprise one or more modules configured to refine the emulsion matrix by constricting the flow path 202 to increase the pressure and velocity of the stream. For example, the flow path 202 may include at least one nozzle 206. In some embodiments, the nozzle 206 may include a mixing element 402 to promote mixing of the components of the emulsion matrix. As shown in FIG. 2 and in more detail in FIG. 4, the nozzle 206 can include a static mixer comprising at least one stator 404 configured to cause the emulsion matrix to spin, resulting in mixing of components in the emulsion matrix. Where the nozzle 206 is downstream of an injection port, for example injection port 204a in injection module 302 as shown, the mixing element may facilitate the dispersion of injected gas within the stream.

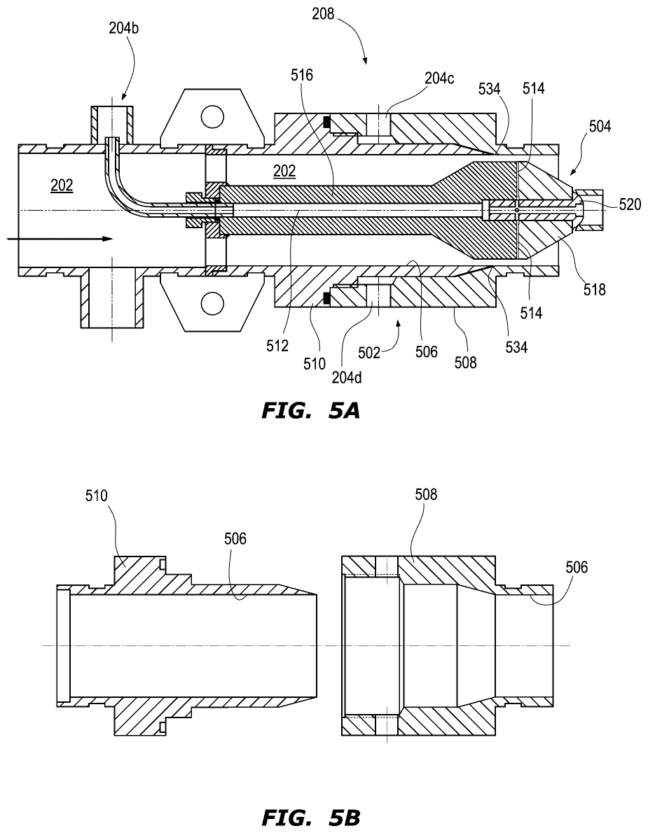

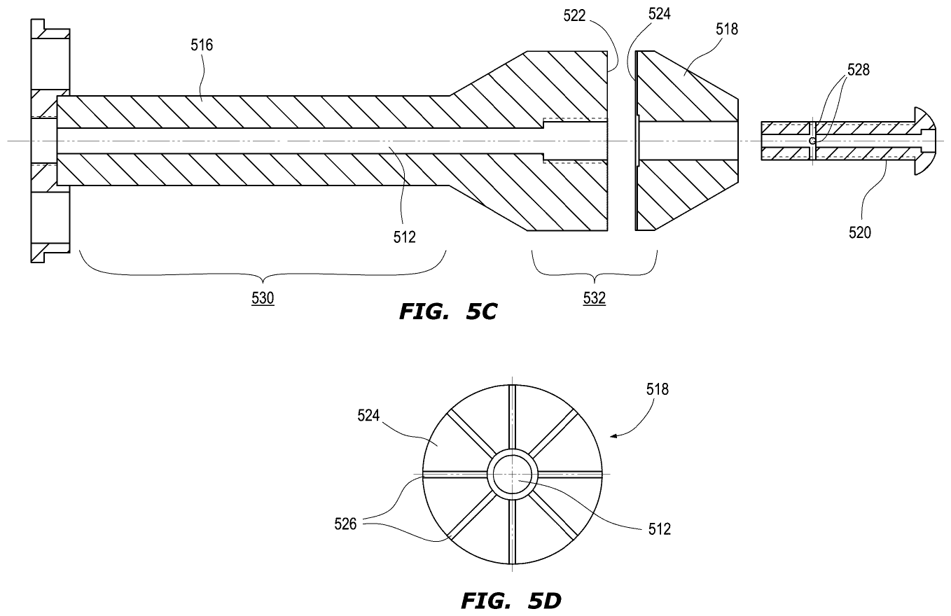

The system 200 can comprise one or more modules configured to facilitate sensitization by producing impinging streams of emulsion matrix and gas. As shown in FIG. 2, the system 200 can comprise an annular gas injector 208. As shown in FIG. 5A, the annular gas injector 208 can comprise a body assembly 502 having an inner surface 506 defining the flow path 202 through the module for the emulsion matrix. As shown in FIG. 5B, the body assembly 502 can comprise an outer body 508 and an inner body 510 that can be fitted together in a nested arrangement to form the flow path 202 within this module. The annular gas injector 208 can further comprise an injector assembly 504 disposed coaxially within the flow path 202. As a result, the flow path 202 assumes an annular configuration defined by the inner surface 506 and the outer surface of the injector assembly 504. An axial channel 512 within the injector assembly 504 can be configured for fluid communication with a gas source and can define a path for injected gas that is coaxial with the annular flow path 202 for the emulsion matrix. The axial channel 512 can be in fluid communication with a plurality of radial channels 514 configured to direct the flow of gas outward to converge with the flow path 202.

As shown in FIG. 5C, the injector assembly 504 can comprise a plurality of elements, including an injector shaft 516 and a cap 518. The cap 518 may be secured by a bolt or other fastener 520 to a distal face 522 of the injector shaft 516. The interaction of these various elements to effect the convergence of emulsion matrix and gas within the annular gas injector 208 can be appreciated with reference to FIG. 5C and FIG. 5D. As shown in FIG. 5C, the injector shaft 516, cap 518 and fastener 520 may each be axially penetrated by a channel so that these pieces combine to define the axial channel 512. These elements may be further configured to define the radial channels 514. Particularly, the distal face 522, the adjacent cap face 524, or both, may include grooves that define radial channels 514 when the cap 518 is secured to the distal face 522. For example, as shown in FIG. 5D the cap face 524 may include a plurality of grooves 526 that communicate with the axial channel 512 and extend radially. When the cap 518 is secured to the injector shaft 516, a radial channel 514 is defined by each groove 526 and the distal face 522. As shown in FIG. 5C, the fastener 520 may also be penetrated by radial holes 528 that each align with a groove 526 when the fastener 520 is in place, thereby providing fluid communication between the axial channel 512 and the radial channels 514. In some embodiments, an O-ring (not shown) may be placed circumferential to the axial channel 512 so as to block access between the axial channel 512 and the radial channels 514, thereby directing gas flow through the cap 518. In such embodiments, the cap 518 may be equipped with a suitable dispersion nozzle in the place of the fastener 520 shown.

The annular gas injector 208 may also be configured to provide a constriction of the flow path 202. For example as shown in FIG. 5C, the injector assembly 504 can include at least two zones 530, 532, where one zone has a greater diameter than the other. The change in diameter between the two zones may be gradual as illustrated in FIG. 5C, or it may be abrupt. The diameter of the second zone 532 is such that the flow path 202 around this zone is constricted relative to that around the first zone 530. In some embodiments, the radial channels 514 may be situated in the second zone so that gas is injected into the narrowed flow path 202. Without wishing to be bound by theory, such an arrangement may facilitate gassing of the emulsion matrix by reducing the flow volume into which the gas is injected.

In some embodiments, fluid communication between the injector assembly 504 and the gas source may be provided via an injection port. This is illustrated in FIG. 2 and FIG. 5A where the injection port 204b is directly connected to the annular gas injector 208. The annular gas injector 208 may further include one or more injection ports to provide entry of gas into the flow path 202 at an additional point within the module. As illustrated in FIG. 5A, two injection ports 204c, 204d may be situated substantially opposite each other across the flow path 202, though other arrangements of the injection ports are also contemplated. Gas introduced via injection ports 204c and 204d may travel between the outer body 508 and the inner body 510 and enter the flow path 202 through an annular entry point 534.

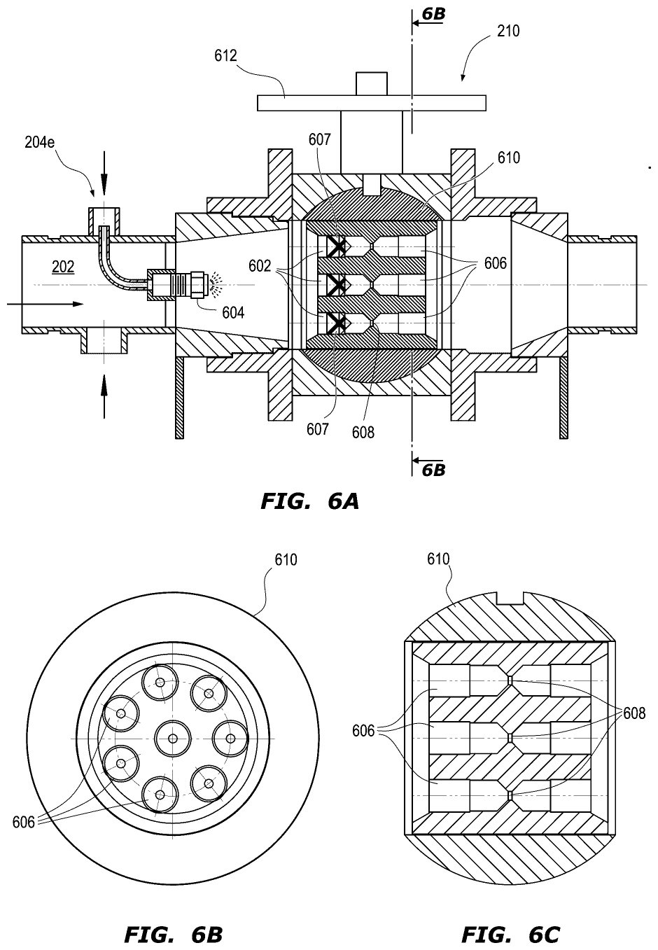

Another module configured to refine the emulsion matrix by constricting the flow path 202 to increase the pressure and velocity of the stream is shown in FIG. 6A through FIG. 6C. In some embodiments, a gas injection cassette 210 can comprise a plurality of inlets 602 where each inlet 602 may be situated at the entrance of one of a plurality of channels 606. The flow path 202 is divided among the channels 606 so that a fraction of the stream is directed down each channel. The inlet 602 in each channel 606 can be configured to direct the stream down that channel. In some embodiments, each inlet 602 can comprise a mixing element 607, such as a stator. In various embodiments, the module may contain from 2 to 12 channels. In particular embodiments, the module can contain 2 to 10 channels, 4 to 8 channels, 6 to 7 channels, 2 to 8 channels, or 4 to 12 channels, and up to as many inlets as there are channels. As illustrated in FIG. 6B, which provides a section view taken at the plane indicated in FIG. 6A, the inlets 602 may be arranged regularly within a plane perpendicular to the flow path 202. As illustrated in FIG. 6A, the gas injection cassette 210 can be situated downstream of an injection port 204e configured to inject a gas into the emulsion matrix stream before the stream enters the array of inlets 602. In some embodiments, the injection port 204e may include a dispersion nozzle 604 to facilitate distribution of gas bubbles among each fraction of the stream.

As shown in FIG. 6C, each channel 606 may include a constriction 608 at which the diameter of the channel narrows significantly. In some embodiments, the constriction 608 may be configured to impart shear to the fraction of the stream within the channel 606. Also, turbulence in the stream resulting from a pressure drop after passing through the constriction 608 may promote mixing of injected gas with the emulsion matrix.

The gas injection cassette 210 may be configured so that it admits transit of material in either of two opposite directions (i.e. forward and reverse) with substantially equal facility. Accordingly, the orientation of the gas injection cassette 210 relative to the flow path 202 may be reversed with substantially no change in its function. For example, after operating in a given orientation for some duration, the gas injection cassette 210 may be reversed so that the material stream flows through the channels 606 in the opposite direction. In some embodiments, a method of cleaning the channels 606 after a period of operation can comprise reversing the orientation of the gas injection cassette 210 for a subsequent period of operation. The gas injection cassette 210 may comprise a rotatable valve 610 within which the channels 606 are disposed. The valve 610 is rotatable at least between two positions in which the channels 606 are in fluid communication with the flow path 202. Stated differently, the valve 610 can be rotated at least 180°. A pivot wheel 612 may be secured to the valve 610 to facilitate rotation.

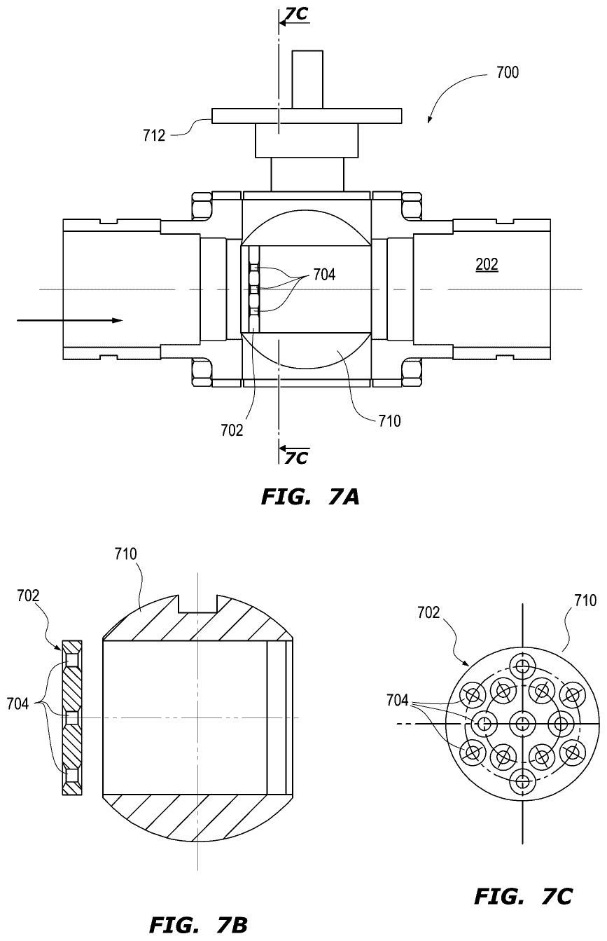

In some embodiments, the explosive delivery system can comprise a pre-shear valve 700 as illustrated in FIG. 7A, either in addition to or instead of the gas injection cassette 210 described above. As shown, the pre-shear valve 700 can comprise a plate 702 perforated by a plurality of holes 704 and situated across the flow path 202 so that the emulsion matrix stream is divided and directed through the plurality of holes 704. The number of holes 704 can be from 2 to 20, such as 2, 3, 4, 5, 6, 7, 8, 9, 10, 11, 12, 13, 14, 15, 16, 17, 18, 19, or 20 holes. An example of an arrangement of 13 holes 704 is illustrated in FIG. 7C, which provides a section view taken at the plane indicated in FIG. 7A. The holes 704 may each be configured to facilitate flow of emulsion matrix through the plate 702. The holes 704 may be additionally or alternatively configured to impart shear to the emulsion matrix stream as the emulsion matrix flows through the holes. In some embodiments, the holes 704 may have chamfered or radiused edges. In some embodiments, the pre-shear valve 700 is configured so that its orientation relative to the flow path 202 may be reversed with substantially no change in its function. For example, as illustrated in FIG. 7A and FIG. 7B, the pre-shear valve 700 may comprise a rotatable valve 710 within which the plate 702 is disposed. A pivot wheel 712 may be secured to the valve 710 to facilitate rotation.

The explosive delivery system 200 may include one or modules configured to homogenize the emulsion explosive resulting from sensitization and refinement of the emulsion matrix by one or more of the modules described above. Accordingly, as shown in FIG. 2, the system 200 may include a homogenizer 212 that comprises elements configured to introduce a shearing stress on a stream of emulsion explosive. In some embodiments, the homogenizer comprises a plurality of homogenizing stages, each stage having such an arrangement of elements.

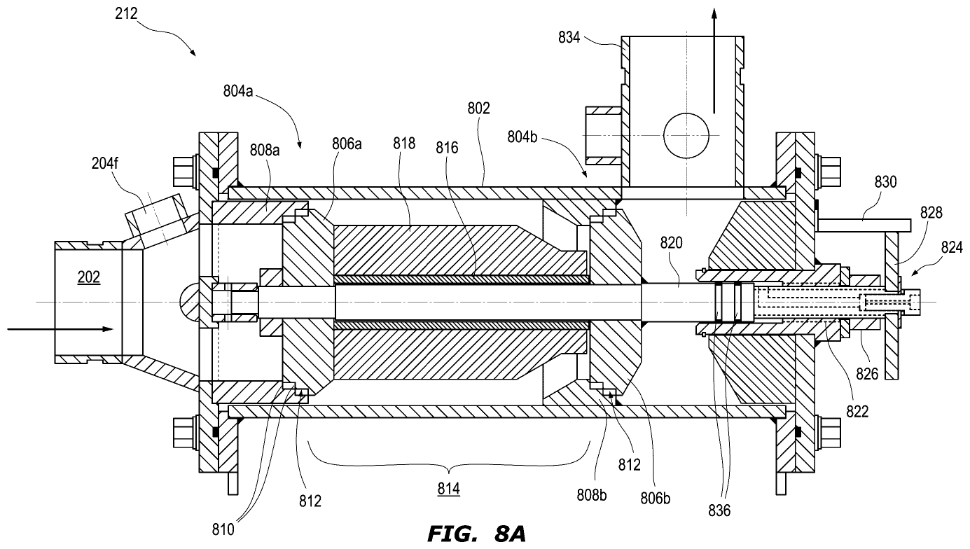

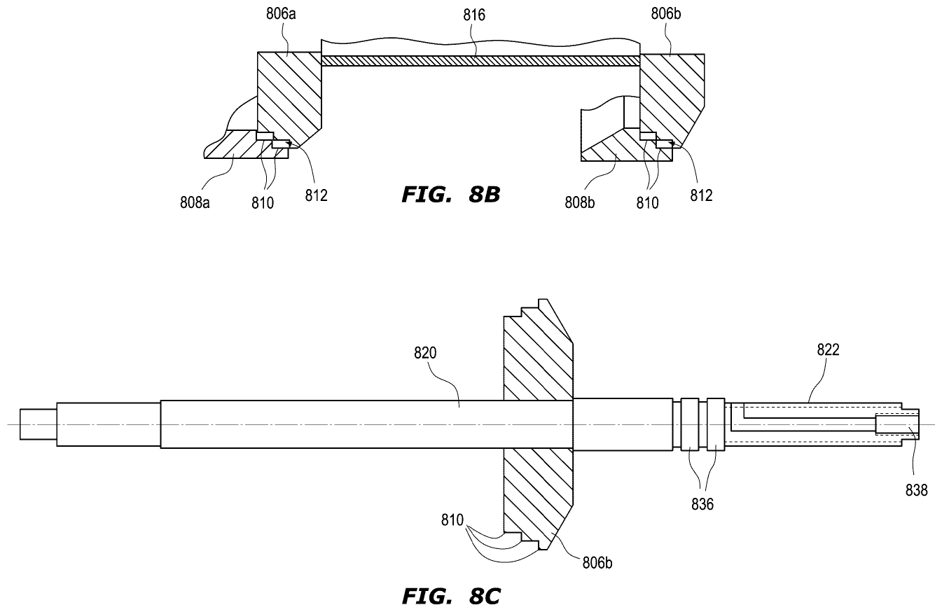

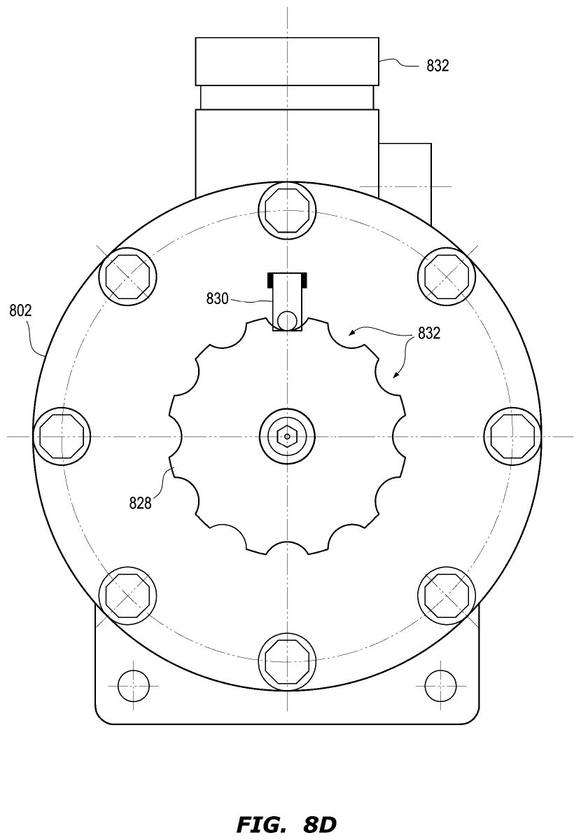

An example of such a configuration is illustrated in the detailed view of homogenizer 212 shown in FIG. 8A through FIG. 8D. The flow path 202 through the homogenizer 212 can be defined in part by a housing 802. The housing 802 may have a substantially cylindrical profile as illustrated in the end view of FIG. 8D, but other suitable geometries are also contemplated. A shear set 804a can be disposed within the housing 802, where the shear set 804a comprises paired shear members 806a, 808a. More specifically, the shear set 804a can comprise a first shear member 806a and a second shear member 808a.

Each shear member in a shear set 804a includes at least one shear edge 810. The shear members 806a, 808a can be arranged so that their respective shear edges 810 are opposed to each other across an intervening gap 812. The shear set 804a is configured such that the stream is forced to flow through the gap 812. For example, as shown in FIG. 8A, the first shear member 806a may be centered within the flow path 202 while the second shear member 808a is disposed at a radial boundary of the flow path 202, such as on an inner surface of the housing 802. In such an arrangement, a sensitized emulsion stream flowing through the homogenizer 212 is directed radially around the first shear member 806a and through the gap 812 between shear members 806a and 808a. The shear edges 810 are configured so that they impart shear on the sensitized emulsion as it passes through the gap 812.

Each shear member may include a plurality of shear edges 810 arranged to be encountered by the sensitized emulsion stream in succession (e.g., such as a stepped arrangement). A shear member may include 1 to 6 shear edge(s), such as 1 shear edge, 2 shear edges, 3 shear edges, 4 shear edges, 5 shear edges, or 6 shear edges. Additional shear edges can also be used as desired. In some embodiments, a shear member may comprise a plurality of tiers, in which the edge of each tier extends beyond that of the tier(s) upstream of it so that the shear edges are arranged in a stepped configuration. In some embodiments, the first shear member can comprise a plurality of stacked plates, and the second shear member can comprise a collar or shoulder having a stepped profile. This is illustrated by the embodiment shown in FIG. 8A, in which each shear member includes a plurality of circular shear edges 810 in a concentric arrangement. As can be seen in the detailed view of FIG. 8B, the shear members are sized so that each shear edge 810 on the first shear member 806a is opposed to a shear edge 810 of similar radius on the second shear member 808a. In an aspect, homogenization may be characterized in terms of the total shear edge length in a shear set, in a homogenizer, or in the system 200 as a whole. In various embodiments, a shear set may comprise about 1 cm to about 90 cm of shear edge. In various embodiments, the homogenizer may comprise about 1 cm to about 180 cm of shear edge (e.g., two shear sets), or about 1 cm to about 270 cm (e.g., three shear sets). In certain embodiments, the system may comprise about 1 cm to about 400 cm of total shear edge. In various other embodiments, a shear set may comprise about 1 cm to about 270 cm of shear edge. In various other embodiments, the homogenizer may comprise about 1 cm to about 540 cm of shear edge, or about 1 cm to about 810 cm of shear edge. And in certain other embodiments, the system may comprise about 1 cm to about 1200 cm of total shear edge. In various embodiments, the total shear applied to the emulsion may be selected based upon the rate or volume of emulsion flow through the homogenizer. For example, in some embodiments, generally lower total shear is employed for lower flow rates or lower flow volumes and generally higher total shear is employed for higher flow rates or higher flow volumes.

The homogenizer 212 can include plural shear sets and thereby provide plural stages of homogenization of a stream during transit. For example, as shown in FIG. 8A, the homogenizer may include one or more additional shear sets 804b comprising a first shear member 806b and a second shear member 808b. As shown, the shear members of shear set 804b may have a similar configuration and arrangement to their counterparts in shear set 804a. The distance 814 between the shear sets 804a, 804b may be at least partly established by a spacer 816 separating the shear sets. A filler element 818 may also be disposed between the shear sets, where the filler element 818 is configured to reduce the volume of the flow path 202. In some embodiments, the length of the spacer 816 may be selected to provide a particular residence time between the homogenization stages. Without being bound by a particular theory, increasing residence time in homogenization of emulsions comprising polymeric emulsifiers may facilitate the alignment of emulsifier molecules in the sensitized emulsion.

In certain embodiments, the length of the spacer may be selected to establish a minimum distance between corresponding elements of the shear sets. For example, as shown in FIG. 8A the distance between first shear member 806a and first shear member 806b is based on the length of the spacer 816. This distance accordingly determines the gap size in shear set 804b relative to that in shear set 804a. Any difference in the gap sizes can be modified by increasing the distance between the first shear members 806a, 806b while holding the distance between the second shear members 808a, 808b constant. This may be achieved by the insertion of one or more additional spacing elements (not shown), such as shims, between the spacer 816 and one of the first shear members. In certain embodiments, one or more shims of a selected thickness can be used to provide a plurality of gap size differentials. In particular embodiments, the shim thickness is from about 0.001 inches to about 0.01 inches, or more particularly about 0.001 inches, about 0.002 inches, about 0.003 inches, about 0.004 inches, about 0.005 inches, about 0.006 inches, about 0.007 inches, about 0.008 inches, about 0.009 inches, or about 0.01 inches. By way of illustration, Table 1 shows gap differences provided by adding 0.005 inch shims to a spacer, where said spacer alone provides a 0.020-inch gap at 804a and a 0-inch gap at 804b. (As also illustrated in this example, under sufficient operating pressure an emulsion matrix can be forced through a gap having an effective width of about or close to 0 inches.)

TABLE 1

| Number of | 804a Gap Size | 804b Gap Size |
|---|---|---|
| 0.005″ Shims | (inches) | (inches) |
| 0 | 0.020 | 0.000 |
| 1 | 0.015 | 0.000 |
| 2 | 0.010 | 0.000 |
| 3 | 0.005 | 0.000 |
| 4 | 0.000 | 0.000 |

The homogenizer 212 may be configured to provide for adjustment of the characteristics of certain elements of the module. In some embodiments, the homogenizer 212 is configured for adjusting the arrangement of the shear members within each shear set. For example, at least one of the shear members in each shear set can be configured so that its position—and therefore the width of the gap—may be adjusted. In certain embodiments such adjustment may be accomplished using an external mechanism. The embodiment shown in FIG. 8A through FIG. 8D provides an example of such a configuration. In this embodiment, each shear set comprises an adjustable first shear member 806a, 806b and a fixed second shear member 808a, 808b. The adjustable first shear members 806a, 806b are secured to an adjustment rod 820 rotatably mounted to the housing 802 and disposed coaxially within the flow path 202. As shown in FIG. 8A, an end 824 of the adjustment rod 820 may exit the housing 802 through a threaded aperture 826 to provide for external manipulation of the adjustment rod 820. The adjustment rod 820 includes a threaded zone 822 configured to engage with matching threads in the aperture 826 so that rotation of the adjustment rod 820 causes longitudinal displacement of the adjustment rod 820 and the first shear members 806a, 806b. Consequently, the position of the first shear members 806a, 806b relative to the fixed second shear members 808a, 808b can be adjusted through rotation of the adjustment rod 820. In various embodiments, the range of gap widths can be from about 0 mm to about 25 mm. In certain embodiments, the range of gap widths can be from about 0 mm to about 16 mm.

Without being bound to a particular theory, the shear stress applied by the shear set may increase with decreasing gap width. In some embodiments, the system may be configured so that the amount of shear applied to the emulsion matrix progressively increases over a plurality of shear events. For example, shear set 804b can have a smaller gap width than shear set 804a, so that the amount of shear applied increases from the first stage to the second stage. In some embodiments, the gas injection cassette 210 and the shear sets 804a and 804b may be configured to apply successively greater amounts of shear to the emulsion matrix.

An adjustment knob 828 may be affixed to the end 824 of the adjustment rod 820 to facilitate manual rotation of the adjustment rod 820. As shown in FIG. 8D, the adjustment knob 828 may have a knurled or notched edge. A locking mechanism may further be included to maintain the rod at a particular rotational position. For example, the housing 802 can include a lock bar 830 configured to engage with notches 832 on the adjustment knob 828 so as to restrict rotation of the adjustment rod 820. In some embodiments, notches 832 may be spaced at intervals selected to correspond to the degree of rotation of the adjustment rod 820 and thereby indicate the longitudinal displacement of the rod and position of the shear member(s) attached thereto.

Additional adjustments that can be made include the inclusion of additional shear members. For instance, the depicted embodiment includes 2 sets of shear members. One or more additional sets of shear members can also be included. Additionally, the distance between the sets of shear members (e.g., first set of shear members and second set of shear members) can also be adjusted.

An outlet 834 for the stream of homogenized emulsion may be situated downstream of the shear sets. To prevent the emulsion from escaping through the aperture 826 instead, one or more O-rings 836 may be disposed on the adjustment rod 820 where it enters the aperture 826. As shown in FIG. 8C, the adjustment rod 820 may further include a release channel 838 in fluid communication with the aperture 826 beyond the one or more O-rings 836, and configured to direct any escaping emulsion outside of the housing 802 in the event of O-ring failure. Escape of emulsion from the release channel 838 may provide an externally visible indication of O-ring failure.

The housing 802 may also include one or more injection ports configured to provide for injection of gas into the flow path 202. As illustrated by injection port 204f in FIG. 8A, the injection port may be configured to provide for gassing upstream of one or a plurality of the shear sets. In certain embodiments, an alternate or additional injection port may be situated between two shear sets.

As noted above, homogenizers in accordance with the present disclosure may be configured to homogenize a stream of sensitized emulsion in a plurality of stages. The number of stages may be selected to impart particular properties to the homogenized product. Without being bound by a particular theory, homogenization in multiple stages may provide more stability in some emulsions, such as emulsions having high viscosity. In various embodiments, the homogenizer may be configured for 2 to 5 homogenization stages. For example, the homogenizer may be configured for 2 stages, 3 stages, 4 stages, or 5 stages. Such configuration can comprise a shear set as described above for all of the stages. Alternatively, the homogenizer may include other elements suited for homogenizing emulsions, such as shear valves, for one or more stages.

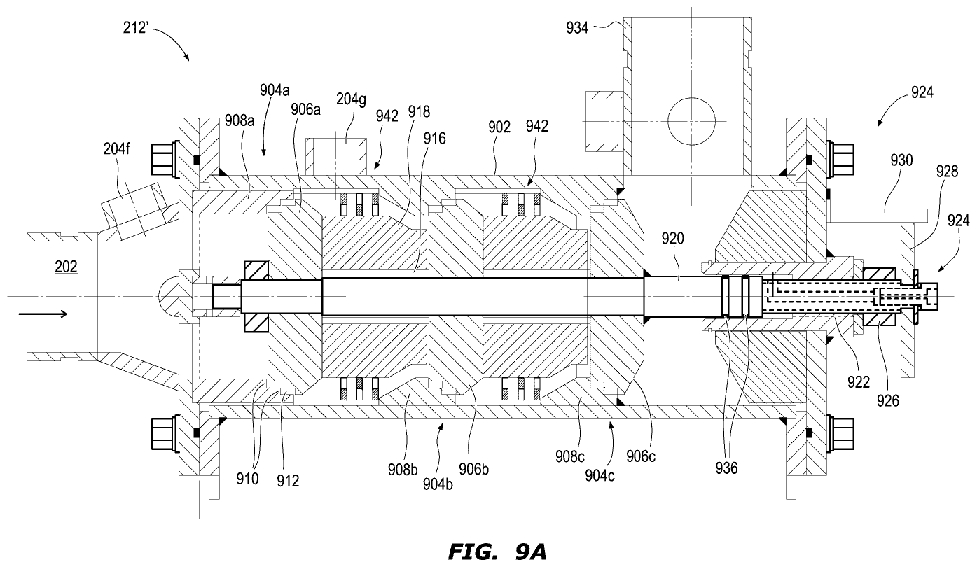

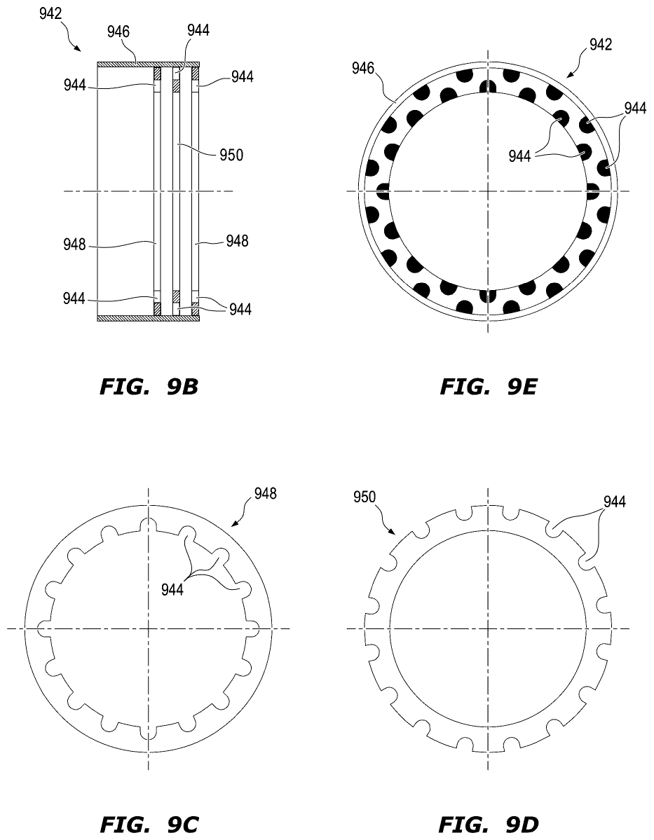

The housing 802 may also include one or more injection ports configured to provide for injection of gas into the flow path 202. As illustrated by injection port 204f in FIG. 8A, the injection port may be configured to provide for gassing upstream of one or a plurality of the shear sets. In certain embodiments, an alternate or additional injection port may be situated between shear sets, such as is shown in FIG. 9A and discussed below.

An example of a homogenizer 212′ providing a plurality of homogenization stages is shown in FIG. 9A. This embodiment includes all of the various features of the homogenizer 212 shown in FIG. 8A, where in each figure corresponding parts are indicated by reference numbers having the same last two digits. Any disclosure provided above with respect to those features as shown in FIG. 8A also applies to the embodiment shown in FIG. 9A. Features that are particular to the example embodiment shown in FIG. 9A are described as follows. As shown, the homogenizer 212′ includes a third shear set 904c in addition to a first shear set 904a and second shear set 904b, said third shear set 904c comprises first and second shear members 906c, 908c. The homogenizer 212′ also includes a plurality of injection ports 204f and 204g. A homogenizer according to the present disclosure can further comprise one or more mixers configured to facilitate mixing of components in the emulsion, for example components added via an injection port. For example, as illustrated by the embodiment shown in FIG. 9A, one or more static mixers 942 may be placed so as to provide mixing stages sequential to the application of shearing stress. In the example of FIG. 9A, a mixer 942 is disposed between the first shear set 904a and the second shear set 904b and also between the second shear set 904b and the third shear set 904c. The mixer 942 can comprise a plurality of disks or rings situated in a series in the flow path 202 and each penetrated by a plurality of holes 944 through which the emulsion is forced to flow. The holes can be arranged so as to achieve repeated dividing and/or folding of the flow of emulsion.

Further structural details of the mixer 942 can be seen in the section view provided in FIG. 9B. The mixer 942 can comprise an optional tubular spacer 946 configured to be disposed at a radial boundary of the flow path 202, such as on an inner surface of the housing 902. A plurality of rings 948, 950, each penetrated by a plurality of holes 944, extend inward from the spacer 946 and across the flow path 202. The plurality of rings 948, 950 can also extend inward from the inner surface of the housing 902 if no tubular spacers 946 are used. The plurality of rings comprises a sequence of two types of each having different hole placements: inner hole rings 948 each having holes disposed at or near its inner edge; and outer hole rings 950 each having holes disposed at or near its outer edge. In each type a hole may be a notch in said edge, so that the boundary of the hole is partly defined by a surface adjacent to that edge, e.g., the inner surface of the housing 902 for an outer hole ring 950, or a filler element 918a or 918b in the case of an inner hole ring 948. This particular design is illustrated by the end view of an individual inner hole ring 948 and an outer hole ring 950 shown in FIG. 9C and FIG. 9D respectively. In some embodiments, the tubular spacer 946 can be used to provide a desired spacing between adjacent rings 948, 950, and/or a desired spacing between the rings 948, 950 and the shear sets.

The relative hole placements in the types of rings 948, 950 are such that their holes are at least partially unaligned in a radial direction. Stated somewhat differently, a plurality of rings 948, 950 arranged in an alternating series presents one or more series of unaligned holes through which the emulsion flows. The two types of rings 948, 950 may also be oriented so that the holes of adjacent rings are at least partially unaligned in a circumferential direction. This arrangement is illustrated in the end view diagram of mixer 942 provided in FIG. 9E, which shows an exemplary array of placements of holes 944 provided by the combination of both ring types.

As further shown in FIG. 9A, three rings 948, 950 are used in the sequential arrangement. In particular, the depicted embodiment includes an inner hole ring 948, followed by an outer hole ring 950, followed by another inner hole ring 948. Other arrangements are also contemplated. For example, an arrangement may include an outer hole ring 950, followed by an inner hole ring 948, followed by another outer hole ring 950. More or less hole rings 948, 950 can also be used as desired (e.g., 2 hole rings 948, 950, or 4, 5, 6 or more hole rings 948, 950).

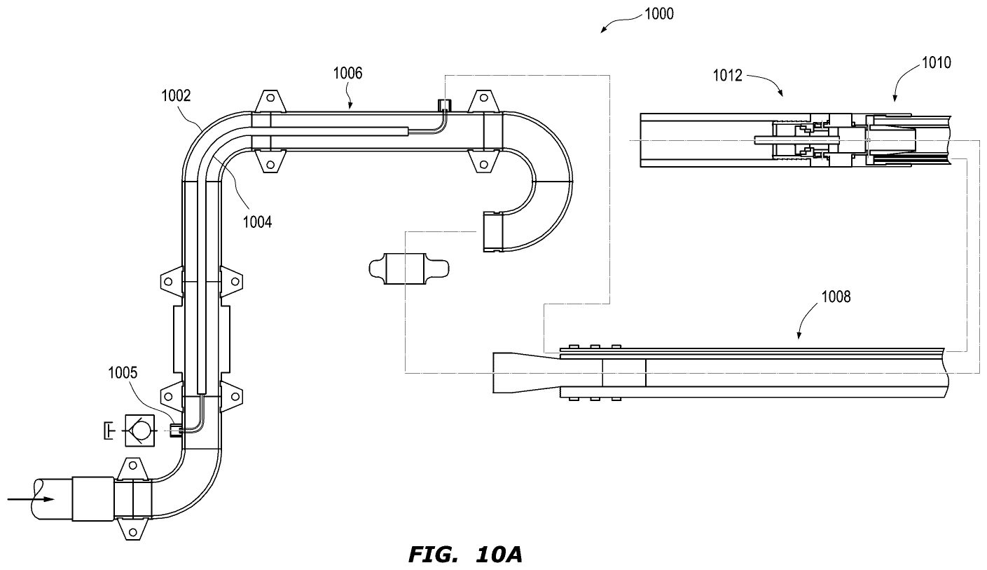

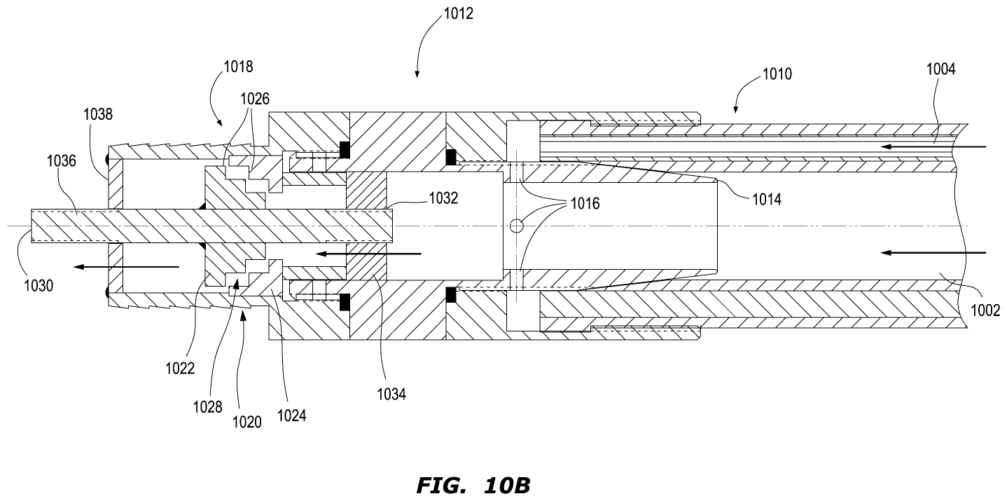

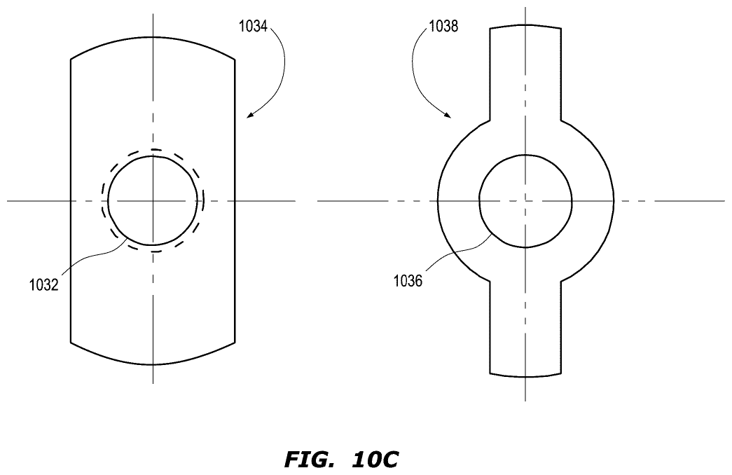

The explosives delivery system 200 can further comprise a delivery device, such as a delivery conduit 1000 as shown in FIG. 10A through FIG. 10C, that is operably connected to the outlet 834 of the homogenizer 212, and configured to convey the explosive emulsion into a borehole. In some embodiments, the delivery conduit may include elements configured to adjust a property of the emulsion immediately prior to delivery. For example, the delivery conduit 1000 may be configured for gassing a homogenized emulsion prior to ejecting it into the borehole. In some embodiments, a delivery conduit can be configured to convey parallel streams of an emulsion and a compressed gas. For example, the conduit may include elements that provide separate fluidic connection to sources of these streams. The conduit can be further configured to combine these streams at a point proximal to an outlet of the conduit so as to introduce bubbles of the compressed gas into the emulsion to produce a sensitized emulsion explosive.

As illustrated in FIG. 10A, the delivery conduit 1000 may include a hose 1002 for conveying a stream of homogenized emulsion explosive from the homogenizer 212, and also a separate gas tube 1004 for conveying a stream of gas from an injection port 1005. As shown, in some embodiments, the delivery conduit 1000 may comprise a section 1006 in which the gas tube 1004 is situated within the hose 1002. In some embodiments, the delivery conduit 1000 can comprise a section 1008 in which the gas tube 1004 is directly adjacent to the hose 1002. The delivery conduit 1000 may further comprise a structure configured to facilitate combining the streams before the explosive product is discharged from an outlet 1010 of the delivery conduit 1000 and into the borehole. As shown in FIG. 10A the outlet 1010 can be fluidically connected to a nozzle 1012 configured to eject the sensitized explosive product into a borehole.

FIG. 10B shows certain aspects of the outlet 1010 and the nozzle 1012 in greater detail. A connector 1014 can be fluidically connected to the hose 1002. The nozzle 1012 may comprise one or more ports 1016 configured for introducing the stream of gas into the stream comprising the homogenized emulsion. The one or more ports 1016 can be configured to fluidically connect the gas tube 1004 to the connector 1014 and thereby combine the stream of gas and the stream of emulsion explosive.

In some embodiments, the delivery conduit 1000 may include one or more modules configured for further refining the homogenized emulsion explosive. As shown in FIG. 10A, the nozzle 1012 may include a homogenizer 1018. The homogenizer 1018 may similar or analogous to those described above. For example, the homogenizer 1018 can include a shear set 1020 comprising a first shear member 1022 and a second shear member 1024. Each shear member 1022, 1024 includes at least one edge 1026. The shear members 1022, 1024 can be arranged so that their respective edges 1026 are opposed to each other across an intervening gap 1028. In various embodiments, the gap 1028 can have a width of about 0 mm to about 16 mm. The shear set 1020 is configured such that the stream is forced to flow through the gap 1028 before exiting the nozzle 1012 in the direction shown by the arrow.

The homogenizer 1018 may be configured to provide for adjusting a characteristic of the shear set 1020. For example, at least one of the shear members 1022, 1024 can be configured so that its position—and therefore the size of the gap 1028—may be adjusted. This illustrated in FIG. 10B, in which the shear set 1020 comprises an adjustable first shear member 1022 and a fixed second shear member 1024. The adjustable first shear member 1022 is secured to an adjustment rod 1030 rotatably mounted at a first end in an aperture 1032 of an adjustment plate 1034. The adjustment rod 1030 can be similarly mounted at a second end in an aperture 1036 of a guide plate 1038. As shown in FIG. 10C, the adjustment plate 1034 and the guide plate 1038 are shaped so as to allow the emulsion explosive stream to flow around them. The ends of the adjustment rod 1030 may include threads configured to engage with matching threads in the respective apertures so that rotation of the adjustment rod 1030 causes longitudinal displacement of the adjustment rod 1030 and the first shear member 1022. Consequently, the position of the first shear member 1022 relative to the fixed second shear member 1024 can be adjusted through rotation of the adjustment rod 1030.

In another embodiment, the nozzle 1012 can optionally include a static mixer in addition to or instead of a homogenizer. Use of a system described as above to prepare an emulsion explosive for subsequent packaging instead of bulk delivery into a borehole is also contemplated.

One of ordinary skill in the art, with the benefit of this disclosure, would understand that any number of systems can be used to implement the processes described herein. Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

1. An apparatus for homogenizing an energetic material, comprising:
a housing defining a flow path for a stream of an energetic material; and
at least one homogenizing stage disposed within the housing, comprising a first shear member and a second shear member, wherein each shear member includes at least one shear edge, and
wherein the at least one shear edge of the first shear member is situated opposite at least one shear edge of the second shear member across a gap through which the flow path passes, and
wherein the at least one shear edge of each shear member is configured to impart a shear stress on the stream in the gap.

2. The apparatus of claim 1, wherein the first shear member is centered within the flow path and the second shear member is disposed at a radial boundary of the flow path.

3. The apparatus of claim 2, wherein the second shear member is disposed on an inner surface of the housing.

4. The apparatus of claim 1, wherein one or both of the shear members each includes 2 to 6 shear edges.

5. (canceled)

6. The apparatus of claim 4, wherein the shear edges are arranged concentrically within the housing.

7. The apparatus of claim 1, wherein the gap has a width of about 0 mm to about 25 mm.

8. (canceled)

9. The apparatus of claim 1, wherein the at least one homogenizing stage is configured so that a width of the gap is adjustable.

10. The apparatus of claim 9, wherein the first shear member is secured to an adjustment rod mounted to the housing so as to be moveable longitudinally within the housing, where an end of said adjustment rod extends outside the housing via an aperture.

11. (canceled)

12. The apparatus of claim 10, wherein the adjustment rod is rotatably mounted to the housing, wherein the adjustment rod includes a threaded zone configured to engage with threads in the aperture so that rotation of the adjustment rod causes longitudinal displacement of the first shear member.

13. The apparatus of claim 12, comprising an adjustment knob secured to the end of the adjustment rod.

14. (canceled)

15. (canceled)

16. The apparatus of claim 13, comprising a locking mechanism configured to engage the adjustment knob so as to restrict movement of the adjustment rod.

17. The apparatus of claim 1, wherein a total length of shear edge in the at least one homogenizing stage is about 1 cm to about 270 cm.

18. The apparatus of claim 1, comprising a plurality of homogenizing stages.

19. (canceled)

20. (canceled)

21. The apparatus of claim 18, wherein a total length of shear edge in the plurality of homogenizing stages is about 1 cm to about 810 cm.

22. The apparatus of claim 1, wherein the housing includes at least one access port configured to provide for injection of a gas into the flow path.

23. The apparatus of claim 1, further comprising at least one mixer.

24. The apparatus of claim 23, wherein the at least one mixer is situated downstream of the at least one homogenizing stage.

25. The apparatus of claim 24, wherein the at least one mixer comprises a plurality of holes arranged in series, wherein each hole in the series is unaligned with an adjacent hole in the series.

26. The apparatus of claim 25, wherein said hole and adjacent hole are unaligned radially, circumferentially, or both.

27. A method of homogenizing an energetic material, comprising directing a stream of the energetic material through the flow path of the apparatus of claim 1.
